(19) United States
(12) Patent Application Publication
(10) Pub. No.: US 2016/0116134 A1
(43) Pub. Date: Apr. 28, 2016

(54) OPTICAL AND INCREASED OLED ILLUMINATION

(71) Applicants: CHUNGHWA PICTURE TUBES, LTD., Taoyuan County (TW); TATUNG UNIVERSITY, Taipei City (TW)

(72) Inventors: Chuang-Hung CHIU, Hsinchu County (TW); Chao-Heng CHIEN, Taipei City (TW); Jen-Chi LEE, New Taipei City (TW)

(21) Appl. No.: 14/585,146

(22) Filed: Dec. 29, 2014

(30) Foreign Application Priority Data
Oct. 28, 2014 (TW) 103137227

(51) Int. Cl. F21V 5/00; H05B 33/12

(52) U.S. Cl. CPC F21V 5/002; H05B 33/12; F21Y 2101/02

(57) ABSTRACT

An optical and increased OLED illumination includes a light-emitting body and an out-coupling film. The light-emitting body has a light-emitting surface. The out-coupling film is located on the light-emitting surface of the light emitting body. The out-coupling film includes a substrate and a plurality of optical micro particles. The index of refraction of the substrate is substantially the same as that of the light-emitting body, and the optical micro particles are uniformly distributed in the substrate.

### RELATED APPLICATIONS

This application claims priority to Taiwanese Application Serial Number 103137227, filed Oct. 28, 2014, which is herein incorporated by reference.

### BACKGROUND

1. Field of Invention

The present invention relates to an optical and increased OLED illumination.

2. Description of Related Art

For a typical lighting instrument that utilizes an organic light-emitting diode (OLEO) as a light source, an out-coupling film may be adhered to a surface of the OLED to increase the brightness of the lighting instrument having the OLED.

Since the index of refraction of the out-coupling film is very different from the index of refraction of the OLED, when the OLED emits light, total reflection usually occurs in the OLED, and also for a portion of the light at a surface of the out-coupling film in contact with air. The totally reflected light of the OLED and the out-coupling film cannot irradiate out, which makes the illuminance of the lighting instrument difficultly to be improved.

In addition, although a micro structure or a lens structure may be used on the surface of the out-coupling film to reflect or refract the light, the manufacturing cost of the lighting instrument is thus increased and the surface of the out-coupling film becomes uneven due to these additional structures. Also, a gap is usually formed between the out-coupling film and the OLED, which makes the light-emitting efficiency of the lighting instrument difficultly to be improved.

### SUMMARY

An aspect of the present invention is to provide an optical and increased OLED illumination.

According to an embodiment of the present invention, an optical and increased OLED illumination includes a light-emitting body and an out-coupling film. The light-emitting body has a light-emitting surface. The out-coupling film is located on the light-emitting surface of the light emitting body. The out-coupling film includes a substrate and a plurality of optical micro particles.

The index of refraction of the substrate is substantially the same as that of the light-emitting body, and the optical micro particles are uniformly distributed in the substrate.

In one embodiment of the present invention, the substrate is made of a material including polydimethylsiloxane (PDMS) or polymethylmethacrylate (PMMA).

In one embodiment of the present invention, the index of refraction of he substrate is about 1.5.

In one embodiment of the present invention, the optical micro particles are made of a material comprising aluminum oxide, zirconium oxide, titanium oxide, ferric oxide, and silicon dioxide.

In one embodiment of the present invention, the size of each of the optical micro particles is about 2 μm.

In one embodiment of the present invention, the optical micro particles are in a range from 1% to 3% by weight of the out-coupling film.

In one embodiment of the present invention, the thickness of the substrate is in a range from 350 μm to 450 μm.

In one embodiment of the present invention, the transmittance of the substrate is in a range from 90% to 100%.

In one embodiment of the present invention, the light-emitting body is an organic light-emitting lamp.

In one embodiment of the present invention, the OLEO illumination includes an optical adhesive. The optical adhesive is between the out-coupling film and the light-emitting surface of the light-emitting body. The index of refraction of the optical adhesive, the index of refraction of the light-emitting body, and the index of refraction of the out-coupling film are substantially the same.

In the aforementioned embodiments of the present invention, since the index of refraction of the substrate of the out-coupling film is substantially the same as that of the light-emitting body, light is not apt to occur total reflection in the light-emitting body when the light-emitting body emits light. Moreover, the optical micro particles are uniformly distributed in the substrate. When light is reflected by a surface of the out-coupling film in contact with air, the reflected light may be reflected and refracted in an outward direction by the optical micro particles, thereby improving the light-emitting efficiency of the light-emitting body. As a result, the out-coupling film of the present invention having the substrate and the optical micro particles may improve the illuminance and the brightness of the OLED illumination, such that product competitiveness of the OLED illumination is further improved.

### BRIEF DESCRIPTION OF THE DRAWINGS

FIG. 1 is a perspective view of an optical and increased OLED illumination according to one embodiment of the present invention;

FIG. 2 is a cross-sectional view of the OLED illumination taken along line 2-2 shown in FIG. 1;

FIG. 3 is a perspective view of the OLED illumination shown in FIG. 1 when being used in a lighting instrument;

FIG. 4 is a cross-sectional view of an optical and increased OLED illumination according to another embodiment of the present invention, in which the position of the cut line is the same that of FIG. 2;

FIG. 5 is a cross-sectional view of an optical and increased OLED illumination according to another embodiment of the present invention, in which the position of the cut line is the same that of FIGS. 2; and

FIG. 6 is a perspective view of an optical and increased OLED illumination according to another embodiment of the present invention.

### DETAILED DESCRIPTION

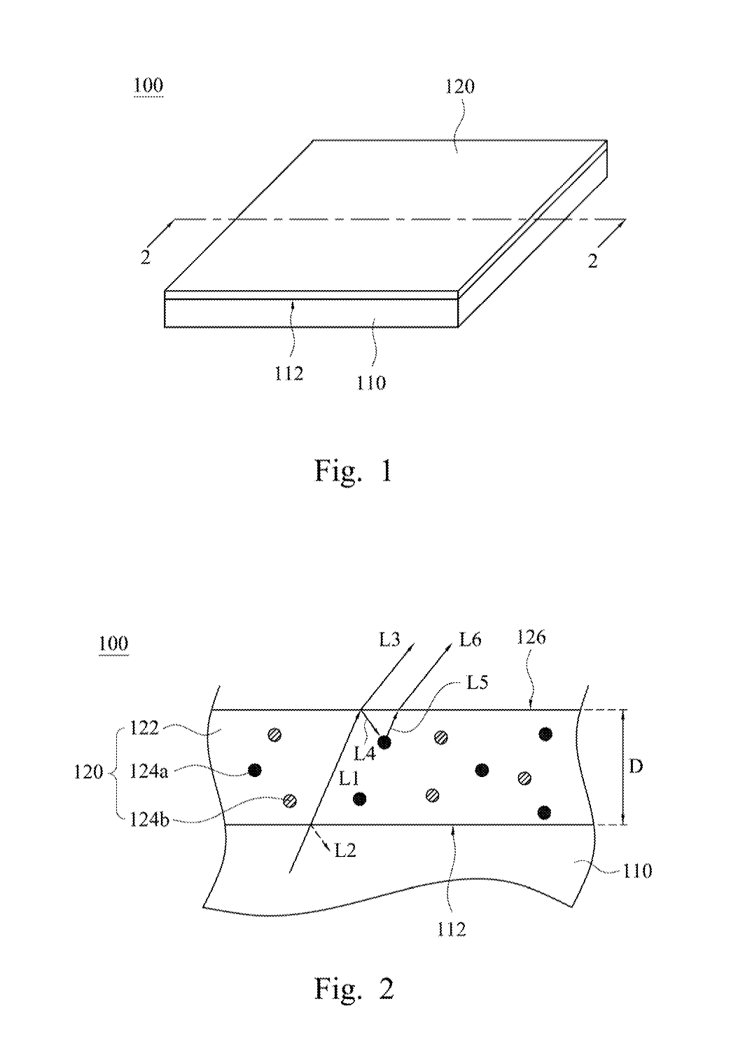

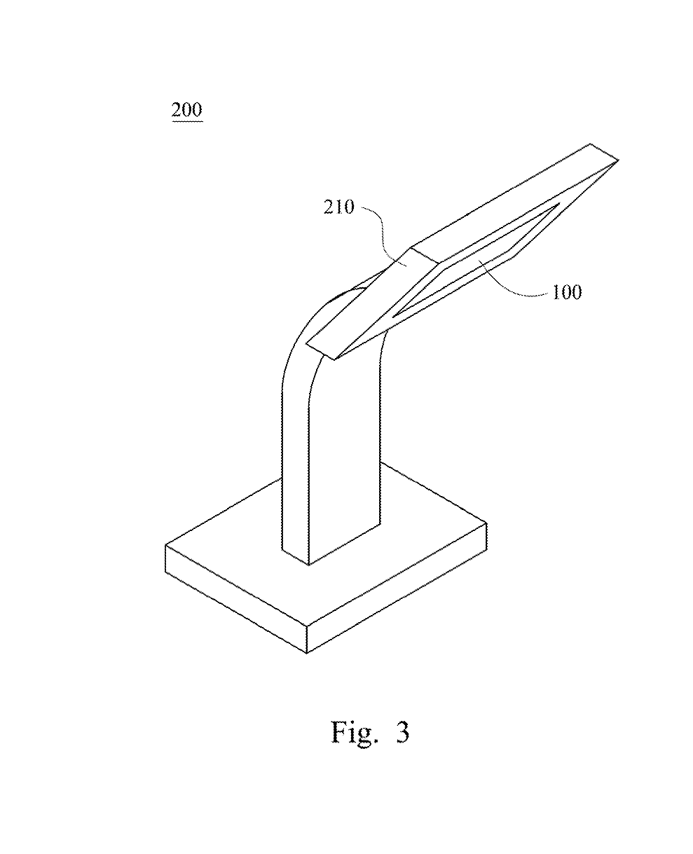

FIG. 1 is a perspective view of an optical and increased OLED illumination 100 according to one embodiment of the present invention. FIG. 2 is a cross-sectional view of the OLED illumination 100 taken along line 2-2 shown in FIG. 1. As shown in FIG. 1 and FIG. 2, the optical and increased OLED illumination 100 includes a light-emitting body 110 and an out-coupling film 120. The light-emitting body 110 has a light-emitting surface 112. The out-coupling film 120 is located on the light-emitting surface 112 of the light emitting body 110. The out-coupling film 120 includes a substrate 122 and a plurality of optical micro particles 124a, 124b. The index of refraction of the substrate 122 is substantially the same as that of the light-emitting body 110, and the optical micro particles 124a, 124b are uniformly distributed in the substrate 122.

In this embodiment, the light-emitting body 110 may be an organic light-emitting diode (OLED) lamp, and the index of refraction of the light-emitting body 110 is about 1.5. It is to be noted that “about” or “substantially” used herein may refer to variances occurring due to manufacturing errors, such as a 10% error. The substrate 122 may be made of a material including polydimethylsiloxane (PDMS), such that the index of refraction of the substrate 122 is also about 1.5. As a result, the index of refraction of the substrate 122 and the index of refraction of the light-emitting body 110 may be substantially the same. However, the material of the substrate 122 is not limited to PDMS. In another embodiment, substrate 122 may be made of a material including acrylic resin, such as polymethylmethacrylate (PMMA).

Since the index of refraction of the substrate 122 of the out-coupling film 120 is substantially the same as that of the light-emitting body 110, light is not apt to occur total reflection in the light-emitting body 110 when the light-emitting body 110 emits light. For example, when light L1 irradiates outwards from the light-emitting surface 112 of the light emitting body 110, the light L1 may completely enter the out-coupling film 120, and reflected light L2 is not apt to be formed. That is to say, the substrate 122 made of PDMS may improve the light-emitting efficiency of the light emitting body 110.

The optical micro particles 124a, 124b in the out-coupling film 120 have a property of total reflection. The optical micro particles 124a, 124b may be selectively made of a material comprising aluminum oxide, zirconium oxide, titanium oxide, ferric oxide, and silicon dioxide. In this embodiment, the material of the optical micro particles 124a is different from that of the optical micro particles 124b. For example, the optical micro particles 124a may be made of a material including aluminum oxide (e.g., Al₂O₃), and the optical micro particles 124b may be made of a material including zirconium oxide (e.g., ZrO₂). The size of each of the optical micro particles 124a, 124b is about 2 μm.

Moreover, the optical micro particles 124a, 124b are uniformly distributed in the substrate 122, which may reflect and refract light in the out-coupling film 120, such that the light-emitting efficiency of the light emitting body 110 is improved. For example, when the light L1 irradiates outwards from the surface 126 of the out-coupling film 120, refracted light L3 and reflected light L4 are formed due to the index of refraction of the substrate 122 is different from that of air. The reflected light L4 may be reflected by the optical micro particle 124a to form light L5. Thereafter, the light L5 may pass through the surface 126 of the out-coupling film 120 to form refracted light L6 that irradiates in an outward direction. In this embodiment, light in the out-coupling film 120 not only may be reflected and refracted by the optical micro particles 124a, but also may be reflected and refracted by the optical micro particles 124b. The optical micro particles 124a, 124b both may improve the light-emitting efficiency and the illuminance of the light-emitting body 110.

That is to say, by the design of the optical micro particles 124a, 124b distributed in the substrate 122, the out-coupling film 120 of the present invention is capable of improving the light-emitting efficiency and the illuminance of the light-emitting body 110. As a result, the out-coupling film 120 having the substrate 122 and the optical micro particles 124a, 124b may improve the illuminance and the brightness of the OLED illumination 100, such that product competitiveness of the OLED illumination 100 is further improved. Compared with the OLED illumination 100 of the present invention and the light-emitting body 110 that is not adhered to the out-coupling film 120, the illuminance may be improved about 44% and the brightness may be improved about 70%.

Moreover, it is more flexible for the design of the OLED illumination 100 due to the out-coupling film 120. For example, designers may select the light-emitting body 110 that has low illuminance and brightness, and use the out-coupling film 120 to improve the illuminance and the brightness of the light-emitting body 110, such that the cost of the OLED illumination 100 may be reduced. Furthermore, since the OLED illumination 100 has the out-coupling film 120, designers may reduce the output power of the light-emitting body 110 to extent the lifespan of the light-emitting body 110.

In this embodiment, the optical micro particles 124a, 124b may be in a range from 1% to 3% by weight of the out-coupling film 120. The transmittance of the substrate 122 may be in a range from 90% to 100%, and the thickness D of the substrate 122 may be in a range from 350 μm to 450 μm. The substrate 122 has high transmittance and thin thickness, and such design is beneficial for light transmission and miniaturized design of OLED illuminations.

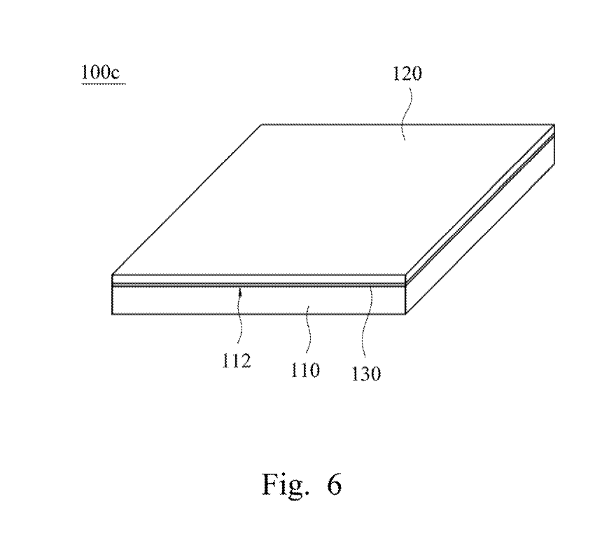

In this embodiment, the material of the out-coupling film 120 is self-adhesive, such that the out-coupling film 120 may be directly stacked on the light-emitting body 110. However, in another embodiment, the out-coupling film 120 may be also adhered to the light-emitting body 110 by utilizing an optical adhesive, as shown in FIG. 6.

FIG. 3 is a perspective view of the OLED illumination 100 shown in FIG. 1 when being used in a lighting instrument 200. As shown in FIG. 3, the lighting instrument 200 includes the OLED illumination 100 and a housing 210. The OLED illumination 100 is assembled on the housing 210 of the lighting instrument 200. The OLED illumination 100 has the out-coupling film 120 (see FIG. 1). Hence, the lighting instrument 200 has the advantages of high illuminance and low cost, such that product competitiveness may be improved. In this embodiment, the lighting instrument 200 is a desk lamp. However, in other embodiments, the OLED illumination 100 may be also assembled to a streetlight, a flush-mounted ceiling lamp, a floor lamp, etc., but the present invention is not limited in this regard.

In the following description, other types of OLED illuminations will be described. It is to be noted that the connection relationships and the materials of the elements described above will not be repeated in the following description.

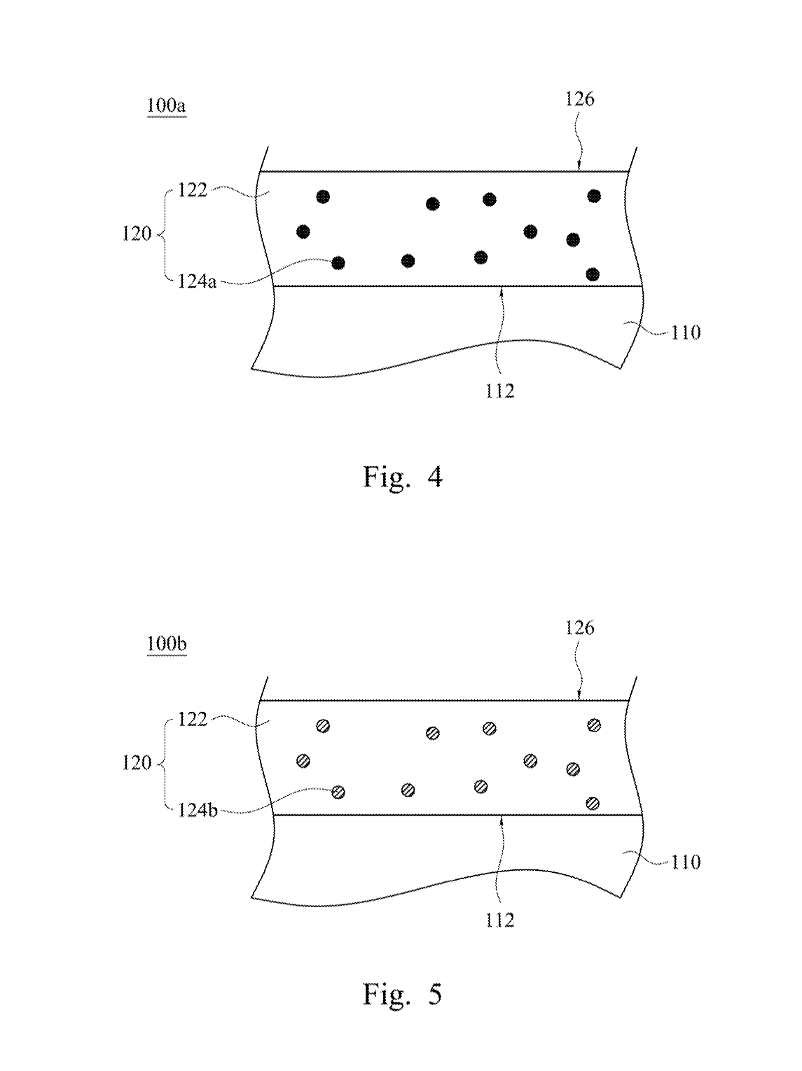

FIG. 4 is a cross-sectional view of an optical and increased OLED illumination 100a according to another embodiment of the present invention, in which the position of the cut line is the same that of FIG. 2. The OLED illumination 100a includes the light-emitting body 110 and the out-coupling film 120. The difference between this embodiment and the embodiment shown in FIG. 2 is that the out-coupling film 120 includes the substrate 122 and the optical micro particles 124a but does not include the optical micro particles 124b shown in FIG. 2.

In this embodiment, the optical micro particles 124a may reflect and refract light in the out-coupling film 120 to improve the illuminance and the brightness of the light-emitting body 110 when emitting light. Moreover, when light is reflected by the surface 126 of the out-coupling film 120 in contact with air, the reflected light may be reflected and refracted in an outward direction by the optical micro particles 124a, thereby improving the light-emitting efficiency of the light-emitting body 110.

FIG. 5 is a cross-sectional view of an optical and increased OLED illumination 100b according to another embodiment of the present invention, in which the position of the cut line is the same that of FIG. 2. The OLEO illumination 100b includes the light-emitting body 110 and the out-coupling film 120. The difference between this embodiment and the embodiment shown in FIG. 2 is that the out-coupling film 120 includes the substrate 122 and the optical micro particles 124b but does not include the optical micro particles 124a shown in FIG. 2.

In this embodiment, the optical micro particles 124b may reflect and refract light in the out-coupling film 120 to improve the illuminance and the brightness of the light-emitting body 110 when emitting light. Moreover, when light is reflected by the surface 126 of the out-coupling film 120 in contact with air, the reflected light may be reflected and refracted in an outward direction by the optical micro particles 124b, thereby improving the light-emitting efficiency of the light-emitting body 110.

FIG. 6 is a perspective view of an optical and increased OLED illumination 100c according to another embodiment of the present invention. The OLED illumination 100c includes the light-emitting body 110 and the out-coupling film 120. The difference between this embodiment and the embodiment shown in FIG. 2 is that the OLED illumination 100c further includes an optical adhesive 130. The optical adhesive 130 is between the out-coupling film 120 and the light-emitting surface 112 of the light-emitting body 110, such that the out-coupling film 120 may be firmly adhered to the light-emitting surface 112 of the light emitting body 110. In this embodiment, the index of refraction of the optical adhesive 130, the index of refraction of the light-emitting body 110, and the index of refraction of the out-coupling film 120 are substantially the same, thereby improving the light-emitting efficiency and the illuminance of the light-emitting body 110. In addition, the transmittance of the optical adhesive 130 may be greater than or equal to 95%.

In the following description, the manufacturing method of the out-coupling film 120 shown in FIG. 2 will be described.

First of all, a soft macromolecular polymer material and a curing agent are placed into a suitable solution to form a mixed solution. In this embodiment, the macromolecular polymer material may be PDMS. The suitable solution may be tetrahydrofuran (THF) or dimethylformamide (DMF). Thereafter, optical micro particles are mixed with the solution in a proportion and stirred the solution, such that the optical micro particles are uniformly distributed in the solution. In this embodiment, the size of each of the optical micro particles is about 2 μm, and the optical micro particles are in a range from 1% to 3% by weight of an out-coupling film.

In the next step, the solution having the optical micro particles may be placed in a vacuum environment for a period of time (e.g., 30 minutes) to draw out bubbles in the solution. Thereafter, the solution may be coated on a plate, and a spin coater is used to control the rotation speed of the plate, such that the solution is uniformly distributed on the plate. The plate is located on the table of the spin coater.

In the next step, the plate and the solution on the plate are placed in a vacuum environment for a period of time (e.g., 30 minutes) to draw out bubbles in the solution. Afterwards, the solution is baked to solidify. For example, the baking temperature may be 75° C., and the baking time may be 1 hour, but the present invention is not limited in this regard.

After the solution is baked and solidified to form a thin film, the thin film is separated from the plate. The thin film may be the out-coupling film 120 shown in FIG. 2. In this embodiment, the solidified thin film may be evenly adhered to a light-emitting body (e.g., an OLED) by utilizing the adhesion of the material of the thin film, such that the OLED illumination 100 shown in FIG. 1 is obtained. Moreover, the solidified thin film may be adhered to a light-emitting body by an optical adhesive, such that the OLED illumination 100c shown in FIG. 6 is obtained.

Compared with prior arts, since the index of refraction of the substrate of the out-coupling film is substantially the same as that of the light-emitting body, light is not apt to occur total reflection in the light-emitting body when the light-emitting body emits light. Moreover, the optical micro particles are uniformly distributed in the substrate. When light is reflected by a surface of the out-coupling film in contact with air, the reflected light may be reflected and refracted in an outward direction by the optical micro particles, thereby improving the light-emitting efficiency of the light-emitting body. As a result, the out-coupling film of the present invention having the substrate and the optical micro particles may improve the illuminance and the brightness of the OLED illumination, such that product competitiveness of the OLED illumination may is further improved.

What is claimed is:

1. An optical and increased OLED illumination, comprising:
a light-emitting body having a light-emitting surface; and
an out-coupling film located on the light-emitting surface of the light-emitting body and comprising:
a substrate, wherein the index of refraction of the substrate is substantially the same as that of the light-emitting body; and
a plurality of optical micro particles uniformly distributed in the substrate.

2. The OLED illumination of claim 1, wherein the substrate is made of a material comprising polydimethylsiloxane (PDMS) and polymethylmethacrylate (PMMA).

3. The OLED illumination of claim 1, wherein the index of refraction of the substrate is about 1.5.

4. The OLED illumination of claim 1, wherein the optical micro particles are made of a material comprising aluminum oxide, zirconium oxide, titanium oxide, ferric oxide, or silicon dioxide.

5. The OLED illumination of claim 1, wherein the size of each of the optical micro particles is substantially 2 μm.

6. The OLED illumination of claim 1, wherein the optical micro particles are in a range from 1% to 3% by weight of the out-coupling film.

7. The OLED illumination of claim 1, wherein the thickness of the substrate is in a range from 350 μm to 450 μm.

8. The OLED illumination of claim 1, wherein the transmittance of the substrate is in a range from 90% to 100%.

9. The OLED illumination of claim 1, wherein the light-emitting body is an organic light-emitting lamp.

10. The OLED illumination of claim 1, further comprising:
an optical adhesive between the out-coupling film and the light-emitting surface of the light-emitting body, wherein the index of refraction of the optical adhesive, the index of refraction of the light-emitting body, and the index of refraction of the out-coupling film are substantially the same.
